(19) United States
(12) Patent Application Publication
(10) Pub. No.: US 2023/0418926 A1
(43) Pub. Date: Dec. 28, 2023

(54) AUTHENTICATION USING MUTABLE DATA

(71) Applicant: Microsoft Technology Licensing, LLC, Redmond, WA (US)

(72) Inventors: Jonathan J. CARUANA, Woodinville, WA (US); Kedar HIRVE, Kent, WA (US); Justin David BROWN, Seattle, WA (US)

(73) Assignee: Microsoft Technology Licensing, LLC, Redmond, WA (US)

(21) Appl. No.: 17/848,235

(22) Filed: Jun. 23, 2022

(51) Int. Cl. G06F 21/44; G06F 21/60; G06F 21/64

(52) U.S. Cl. CPC G06F 21/44; G06F 21/602; G06F 21/64; G06F 2221/2137

(57) ABSTRACT

Software-based authentication techniques may use mutable authentication data that changes to deter counterfeiters from making clones of authentic clients. An authentication service may issue mutable authentication data to a client and store the mutable authentication data in association with an identifier of the client. The client may authenticate by presenting the most recently issued mutable authentication data to the authentication service. Upon successful authentication, the authentication service may issue updated mutable authentication data to the client. Any clones that cannot present the most recent mutable authentication data may be rejected by the authentication service. By changing the mutable authentication data, counterfeiters cannot make a large number of clones that all work at the same time.

### BACKGROUND

Many electronic devices (e.g., computers, smartphones, and game consoles) are used in conjunction with accessory devices (e.g., mice, headphones, game controllers). Therefore, accessory devices represent a large market, and making accessories as well as licensing third-parties to make accessories can be important revenue sources.

### SUMMARY

The concepts described herein relate to software-based authentication techniques using mutable authentication data. The use of mutable authentication data that changes often can combat counterfeiters from making workable cloned accessories. The present concepts may render cloned accessories inoperable (or at least not consistently operable) to deter mass production and sale of unauthorized accessories.

To demonstrate the implementations and operations of the authentication techniques that use mutable data, the present concepts will be described below in the context of authenticating game controller accessory devices. However, these authentication techniques can have a wide range of applications in various industries, and are not limited to authenticating controllers in the gaming field.

### BRIEF DESCRIPTION OF THE DRAWINGS

The detailed description below references accompanying figures. The use of similar reference numbers in different instances in the description and the figures may indicate similar or identical items. The example figures are not necessarily to scale.

FIG. 1 illustrates an example authentication scenario in which some implementations of the present concepts may be used to detect clones.

FIG. 2 illustrates an example system, consistent with some implementations of the present concepts.

FIG. 3 illustrates example communications, consistent with some implementations of the present concepts.

FIG. 4 illustrates a flow diagram of an example authentication server method, consistent with some implementations of the present concepts.

FIG. 5 illustrates a flow diagram of an example authentication client method, consistent with some implementations of the present concepts.

### DETAILED DESCRIPTION

Overview

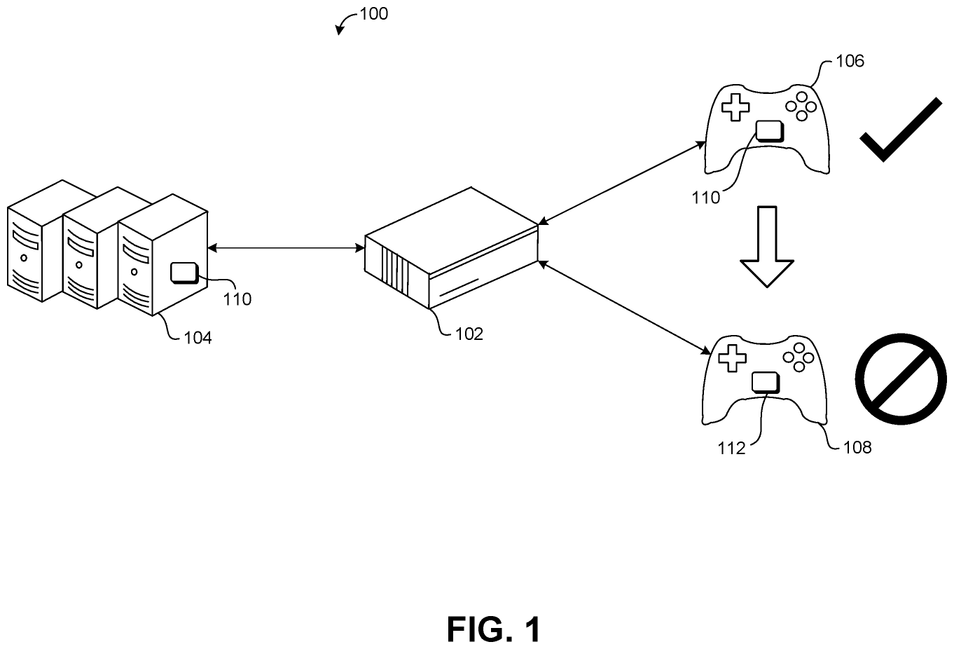

FIG. 1 illustrates an example authentication scenario 100 in which some implementations of the present concepts may be used to detect clones. As mentioned above, the present concepts will be described in the context of detecting cloned counterfeit game controllers, but the same or similar concepts may be used in other contexts.

The authentication scenario 100 illustrated in FIG. 1 may include a game console 102. The game console 102 may be any electronic device that allows a user to play a game using one or more accessories. The game console 102 may include processing capabilities and/or storage capabilities to store and run one or more games. For example, the game console 102 may include a personal computer (“PC”), a smartphone, a virtual reality headset, or a typical standalone game console.

The game console 102 may connect to a game server 104, for example, through the Internet. The game server 104 may host online multi-player games, store game statistics and user profiles, authenticate user accounts, etc.

The game console 102 may include or connect with one or more accessory devices (such as a display, a keyboard, a mouse, speakers, headphones, a storage device, and game controllers) to enable users to interact with games by providing inputs and/or receiving outputs. The game console 102 may connect to an accessory device via wire (e.g., a universal serial bus (USB) cable) or wirelessly (e.g., Wi-Fi or Bluetooth).

For example, an authentic game controller 106 may be approved to be used with the game console 102 for playing games. However, a counterfeit game controller 108 may be cloned from the authentic game controller 106 by a malicious actor without authorization and sold in the market. Conventional techniques are unable to distinguish between the authentic game controller 106 and the counterfeit game controller 108. Therefore, there is a need to prevent the counterfeit game controller 108 from working with the game console 102, for example, through an authentication check.

Technological Problems

One conventional authentication technique involves a game console provider selling security chips to accessory vendors who make game controllers. Each security chip may include unique static authentication data, such as a unique certificate and a unique private key. A game controller manufacturer may take a license for a specific number of security chips corresponding to the number of game controllers it plans to make and sell. Then, the game controller manufacturer may install a security chip inside every game controller it manufactures. Therefore, each legitimate game controller contains unique static authentication data.

When the game controller connects to a game console, the game console may send a challenge to the security chip inside the game controller. In response, the security chip may sign the challenge with the private key, and send the signed challenge back to the game console. Then, the game console can validate the signed challenge sent by the game controller using a certificate and a public key stored in the game console. Therefore, the game console can authenticate that the security chip inside the game controller was provided by the game console provider and that the game controller is authentic.

However, a counterfeiter can clone the authentic game controller, without permission, to make a counterfeit game controller. For instance, a malicious actor can break the security chip, extract the private key, make a counterfeit chip, and sell a counterfeit game controller that includes the counterfeit chip. Therefore, when the counterfeit game controller connects to a game console, the counterfeit game controller will impersonate an authentic game controller by spoofing the same static authentication data that is stored in the authentic game controller. Moreover, once the malicious actor is able to extract static authentication data from an authentic game controller, the malicious actor can produce many cloned counterfeit game controllers that have the same static authentication data. The multiple counterfeit game controllers may all be able to trick different game consoles into passing the authentication check, because there is no uniqueness check performed by the game consoles. Also, even if an individual game console could deny multiple game controllers with the same static authentication data from connecting to it, the malicious actor can still profit from selling a massive number of counterfeit game controllers, because the game consoles are sold to different customers who individually may not necessarily connect multiple counterfeit game controllers to the same game console. Therefore, the conventional authentication technique allows a malicious actor to buy one legitimate game controller from the market, extract the static authentication data from the single licensed game controller, and embed the static authentication data into countless counterfeit game controllers.

One technical problem associated with conventional authentication techniques is that the private key used to authenticate the game controller is an unchanging constant. As such, once a cloned game controller is manufactured with the same static authentication data as the authentic controller, the game console cannot distinguish between the cloned game controller and the authentic game controller, which remain identical. Thus, there is a technical need to provide an improved authentication paradigm that can allow the game console to distinguish between an authentic game controller versus a cloned counterfeit game controller.

Technological Solutions

The present concepts relate to authentication techniques using mutable authentication data. Mutable authentication data may be mutated (e.g., changed, updated, replaced, overwritten, or reset). For example, referring again to FIG. 1, the game server 104 and the authentic game controller 106 may both store mutable authentication data, such as mutable controller authentication data (“CAD”) 110 that changes. The mutable CAD 110 stored in the game server 104 and the authentic game controller 106 may be changed periodically and/or upon certain events (e.g., every time the authentic game controller 106 connects to the game console 102), such that an old CAD 112 is no longer valid for authentication. In one implementation, an authentication service (within the game server 104 or remote from the game server 104) may generate and provide an updated mutable CAD 110 to the authentic game controller 106 for storage. During an authentication check, the authentic game controller 106 may be asked to provide the latest mutable CAD 110 that matches the latest mutable CAD 110 stored in the game server 104 in order to be authenticated. Upon successful authentication, the authentication service may generate and provide yet another updated mutable CAD 110 to the authentic game controller 106 for storage. That is, the authentication service may keep track of the latest mutable CAD 110 provided to individual authentic game controllers 106. Any counterfeit game controller 108 that presents an old CAD 112 that does not match the latest mutable CAD 110 may fail the authentication check.

The present concepts need not necessarily stop the counterfeiters from cloning game controllers, such as by making it difficult to extract secret information from security chips. Rather, the present concepts may render the cloned game controller unusable, thus making it commercially unviable for counterfeiters to mass-produce cloned game controllers.

Because the authentication service may require a game controller to identify itself as well as to provide the latest mutable CAD that it received the last time it was authenticated, only that particular game controller having the latest mutable CAD may be authenticated by the authentication service. Even if a malicious actor were to make multiple counterfeit game controllers that all contain the same latest CAD, only one of them that successfully passes the next authentication check will receive an updated mutable CAD from the authentication service. This would render all other counterfeit game controllers that now contain the outdated CAD unusable, because if they try to authenticate by presenting the outdated CAD, the authentication service will reject the outdated CAD. Accordingly, the present concepts can combat counterfeiters by rendering their cloned accessories unusable—at least all but one unusable—because the mutable authentication data changes.

Unlike conventional techniques that use static authentication data, the present concepts may use mutable authentication data that is stored in the accessory and stored by the authentication service. This paradigm enables the authentication service to identify the authentic accessory that received the latest mutable authentication data that was generated during the last authentication check, as distinguished from cloned accessories that cannot present the latest mutable authentication data and/or present outdated authentication data. Furthermore, because the authentication service updates the mutable authentication data (for example, at every opportunity when the accessory connects to the authentication service), even if a counterfeiter clones multiple accessories, only one will be usable at a time.

Some implementations of the present concepts may incorporate varying degrees of resiliency or robustness, for example, to account for possible errors and/or data loss involving the exchange of mutable authentication data. For instance, if the authentication service detects an error in the authentication process (e.g., the accessory failed to write and store the updated mutable authentication data), then the authentication service may heal the mutable authentication data by allowing the accessory to be authenticated even without presenting the correct mutable authentication data and issue updated mutable authentication data to the accessory. However, if too many broken authentication processes are detected, the authentication service may determine that this represents a cloning scenario and may prevent the clones from authenticating.

System Devices

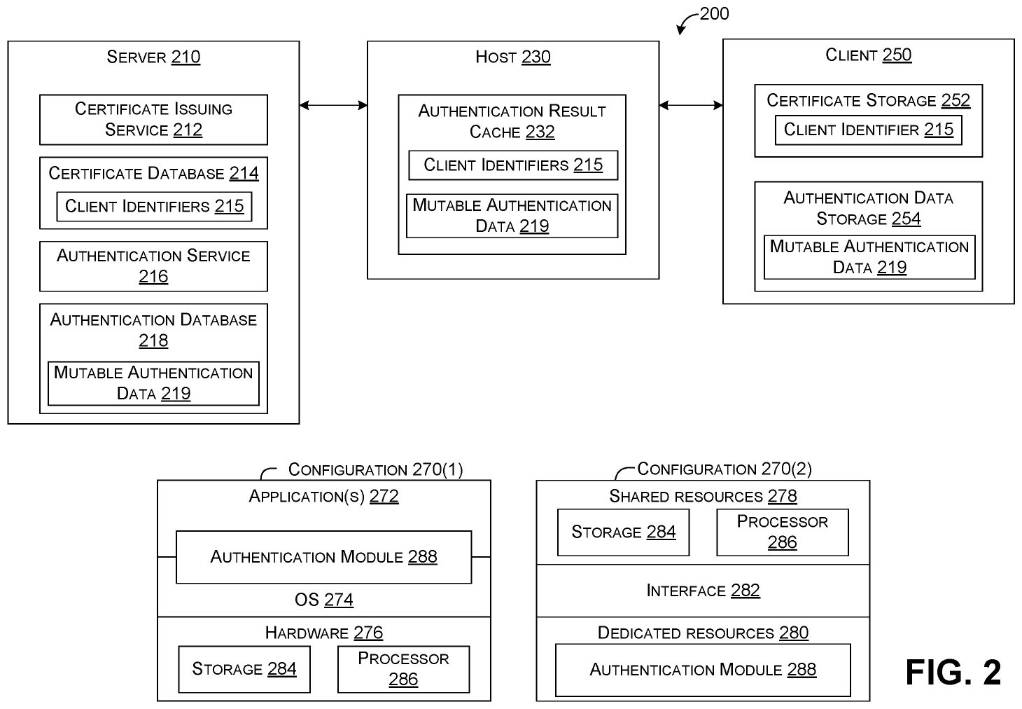

FIG. 2 illustrates an example system 200, consistent with some implementations of the present concepts. The system 200 may include a server 210, a host 230, and a client 250. Although FIG. 2 illustrates only one server 210, one host 230, and one client 250 for simplicity of explaining the present concepts, the system 200 may include multiple servers 210, multiple hosts 230, and/or multiple clients 250.

In this example, the host 230 may try to authenticate the client 250 using an authentication service 216 provided by the server 210. For example, the host 230 may include a game console, and the client 250 may include a game controller. However, the present concepts may be used in other scenarios. For example, the client 250 may authenticate directly with the server 210.

The server 210 may include one or more server computers that have processing capabilities and storage capacity. Consistent with some implementations of the present concepts, the server 210 may assign a unique client identifier 215 to each client 250. Optionally, in one implementation, the server 210 may include a certificate issuing service 212 that generates and issues unique certificates containing the unique client identifiers 215 to be stored in the clients 250. In one implementation, the client identifiers 215 may include unique sequential numbers. In another implementation, the client identifiers 215 may include randomly generated unique numbers and/or randomly generated unique strings. In another implementation, the client identifier 215 may be derived from authentication data. For example, the client identifier 215 may include a public key itself, a hash of the public key, and/or a hash of the certificate. Any formatting and any size of the client identifiers 215 are possible so long as they are unique to each client 250.

In some implementations, the certificate may include other information, such as device type, vendor identifier, batch identifier, when the certificate was issued, to whom the certificated was issued, the signing entity, the capabilities of the device, whether encryption should be used, the type of authentication that should be used, etc. In some implementations, the certificates may be formatted using a public key certificate standard, such as the X.509 standard. In one implementation, the certificates may never expire or have expiration dates very far in the future so as to be irrelevant.

In some implementations, the certificates may be signed. For example, the provider of the host 230 may sign the certificates using its private key. In some scenarios, an accessory intermediate certification authority (“CA”) may sign the certificates using its private key. The provider of the host 230 may securely store the private key of the accessory intermediary CA, which would not be stored on any client 250.

The server 210 may include a certificate database 214 for storing the certificates of the clients 250. Therefore, the certificate database 214 may store multiple client identifiers 215 associated with multiple clients 250. In some implementations, the certificates may be static and never change.

Consistent with some implementations of the present concepts, the server 210 may include the authentication service 216. The authentication service 216 may perform one or more authentication checks to authenticate the client 250. For example, the authentication service 216 may authorize the client 250 to be used with the host 230. In other contexts, the authentication service 216 may authorize the client 250 to be used with the server 210 and/or with other servers.

Consistent with some implementations of the present concepts, the authentication service 216 may generate and issue mutable authentication data 219 to the client 250. For example, the mutable authentication data 219 may include a randomly or arbitrarily generated number and/or string, such as a nonce. Alternatively or additionally, the mutable authentication data 219 may include a timestamp, a serial number, and/or a signature. In the example context where the client 250 is a game controller, the mutable authentication data 219 may include a mutable CAD. The mutable authentication data 219 may have a fixed size (e.g., 4 kilobytes) or have varying sizes.

The server 210 may include an authentication database 218 for storing the mutable authentication data 219 generated and issued by the authentication service 216. In one implementation, the mutable authentication data 219 may be stored in association with the client identifiers 215 of the clients 250 to which the mutable authentication data 219 were issued. Accordingly, the authentication service 216 may know all valid client identifiers 215 of the clients 250 as well as their assigned mutable authentication data 219 in order to run authentication checks. In some implementations, the authentication database 218 may store additional information, such as the date and time when the mutable authentication data 219 was issued, the data and time of successful authentication checks and/or failed authentication checks, the date and time of the last reset or recovery where new mutable authentication data 219 was issued even though the correct latest mutable authentication data 219 was not presented by the client 250. The authentication database 218 may also store information related to the host 230, such as metadata regarding the identity and/or the location of the host 230.

Consistent with some implementations of the present concepts, the authentication service 216 may authenticate the client 250 if the client 250 provides the correct mutable authentication data 219 that was last issued by the authentication service 216 to the client 250. For example, the authentication service 216 may issue new mutable authentication data 219 to the client 250 to be stored and then presented for future authentication check(s). For instance, the mutable authentication data 219 may be updated periodically (e.g., hourly, daily, weekly, monthly, etc.) and/or upon specific events (e.g., at every authentication check). In one implementation, the expiration period of the mutable authentication data 219 may be set by a policy. Such a policy (e.g., maintained by the authentication service 216 in the server 210) may be controlled to reduce the number of times the mutable authentication data 219 is written to the server 210, the host 230, and/or the client 250, thereby prolonging the lifespan of any flash memory with limited endurance. If the client 250 presents outdated authentication data, then the authentication service 216 may refuse to authenticate the client 250.

Accordingly, even if a counterfeiter clones the authentic client 250 and extracts the mutable authentication data 219 to make many clones, all of the clones would be unable to authenticate and would stop working because their authentication data would become outdated after the authentic client 250 authenticates and receives updated mutable authentication data 219 from the authentication service 216.

Alternatively, the authentic client 250 and all but one of the clones would be unable to authenticate after one of the clones authenticates and receives updated mutable authentication data 219 from the authentication service 216. In either case, the counterfeiter would be deterred from cloning a large number of clones from one authentic client, since only one would authenticate successfully with updated mutable authentication data 219 and the rest would have outdated authentication data. The present concepts need not be able to distinguish between an authentic client and a cloned client. The present concepts may simply render all but one of the clones inoperable to sufficiently disincentivize counterfeiters from making clones.

In some implementations, the authentication service 216 may store more than one mutable authentication data 219 in association with each client identifier 215 in the authentication database 218. For example, the authentication database 218 may store the two most recent mutable authentication data 219 for each client identifier 215, for example, in a first-in, first-out fashion. As such, the authentication service 216 may authenticate the client 250 that presents not the latest mutable authentication data 219 but rather the second most recent mutable authentication data 219. This setup allows the authentication service 216 to be resilient to possible errors and/or failures that occur while the client 250 is receiving the updated mutable authentication data 219 over a network and/or writing the updated mutable authentication data 219 to storage. Alternatively, three or higher numbers of the most recent mutable authentication data 219 may be stored in association with the client identifier 215 in the authentication database 218, and the client 250 may present any one of the stored mutable authentication data 219 to be authenticated. A higher number of stored mutable authentication data 219 per client identifier 215 may build an even higher degree of robustness to the authentication service 216.

In some implementations, the authentication service 216 may maintain a disallowed list (e.g., a blocklist) of prohibited clients. For example, one or a higher number of failed authentication attempts may cause the client identifier 215 to be added to the disallowed list. Furthermore, concurrent authentication attempts by multiple clients having the same client identifier 215 or multiple authentication attempts from distant geographical locations (e.g., the same certificate being presented 1,000 miles apart within 10 minutes) may be flagged as a suspicious activity and the associated client identifier 215 may be added to the disallowed list. As such, future attempts to authenticate by these prohibited clients may be rejected outright regardless of any authentication data presented by the prohibited clients. The client identifiers 215 (or the certificate containing the client identifiers 215) may be kept in the disallowed list forever or for a temporary period (e.g., a lockout period).

Although FIG. 2 illustrates the certificate issuing service 212, the certificate database 214, the authentication service 216, and the authentication database 218 as being included in the server 210, alternative configurations are possible. For example, the certificate issuing service 212, the certificate database 214, the authentication service 216, and the authentication database 218 may be included in different servers and/or included in different storage devices. In other implementations, the certificate database 214 and/or the authentication database 218 may be remote from the server 210.

The client 250 may be any device, accessory, or article that can be authenticated. For example, the client 250 may include a display, a keyboard, a mouse, speakers, headphones, game controllers, a hard drive, a removable storage, a card, a key, a badge, a remote control, etc. Although FIG. 2 illustrates the client 250 as a hardware device, the client 250 may be a software module that can store and/or access the client identifier 215 and the mutable authentication data 219. Despite ongoing advances in hardware security and/or encryption, the client 250 may be copied, forged, cloned, and/or counterfeited using various techniques.

In some implementations, all or some functions of the client 250 may be restricted unless the client 250 has been authenticated. In one example scenario, the ability to use the client 250 with the host 230 may be limited until the client 250 is authenticated by the authentication service 216. In alternative implementations, the client 250 may initially be permitted to be used with the host 230 while the authentication check is being performed in the background with the authentication service 216. If the authentication check passes, then the continued use of the client 250 with the host 230 may be permitted. If the authentication check fails, then the use of the client 250 with the host 230 may be disabled entirely or partially.

Consistent with some implementations of the present concepts, the client 250 may store a certificate that includes the client identifier 215 and may also store the mutable authentication data 219, for example, in nonvolatile memory. In one implementation, the client 250 may include a certificate storage 252 for storing the certificate that includes the client identifier 215, and the client 250 may also include an authentication data storage 254 for storing the mutable authentication data 219. The certificate storage 252 and the authentication data storage 254 may be in the same storage or in different storages. In other implementations, the certificate storage 252 and/or the authentication data storage 254 may be remote from the client 250.

The certificate stored in the client 250 may have been issued by the certificate issuing service 212 of the server 210. In some implementations, the certificate may be stored in the client 250 at the time of manufacturing the client 250. The certificate may not ever change and thus may be stored in read-only memory. The certificate may be stored using one or more protection techniques, such as encryption and/or password protection, to make it difficult to extract. In one implementation, the certificate may be stored in a protected storage, such as a trusted platform module (TPM). However, using the present concepts, even if a counterfeiter is able to extract the certificate and copy it to make multiple clones, those clones may not be able to authenticate with the authentication service 216. Thus, the present concepts provide a technical anticloning solution that is hardware platform and encryption neutral. Thus, as hardware and security improvements are made and countered by malicious actors, the present anticloning solutions continue to be effective.

The mutable authentication data 219 stored in the client 250 may have been issued by the authentication service 216 of the server 210. In one implementation, whenever the authentication service 216 issues the client 250 new mutable authentication data 219, the client 250 may write the new mutable authentication data 219 to the authentication data storage 254. In one implementation, when the new mutable authentication data 219 is written on the client 250, any old mutable authentication data may be overwritten. Accordingly, the authentication data storage 254 in the client 250 may include nonvolatile read-write memory. For example, the authentication data storage 254 may include flash solid state drive (SSD) memory.

In some implementations, the client 250 may store more than one mutable authentication data 219 in the authentication data storage 254. For example, the authentication data storage 254 may store the two most recent mutable authentication data 219 that the client 250 received from the authentication service 216, for example, in a first-in, first-out basis. As such, the client 250 may present both of the stored mutable authentication data 219 to the authentication service 216, and the authentication service 216 may authenticate the client 250 based on any one of the two presented mutable authentication data 219 that matches one or more of the latest mutable authentication data 219 stored in the authentication database 218 of the server 210.

These implementations may allow the authentication service 216 to be more resilient to possible errors and/or failures that occur while the client 250 is receiving the updated mutable authentication data 219 over a network and/or writing the updated mutable authentication data 219 in the authentication data storage 254. For example, the client 250 may erroneously disconnect from a network and lose its connection to the authentication service 216, the client 250 may experience an error while writing the latest mutable authentication data 219 to the authentication data storage 254, or the client 250 may unexpectedly lose power. These and any other unexpected errors could prevent the client 250 from receiving and storing the updated mutable authentication data 219, which would cause the client 250 to fail to be authenticated during the next authentication check. By storing multiple mutable authentication data 219, the client 250 may be resilient to occasional errors and still pass future authentication checks.

In one implementation, the mutable authentication data 219 may be stored in the client 250 using one or more protection techniques, such as encryption and/or password protection, to make it difficult to extract. However, using the present concepts, even if a counterfeiter is able to extract the mutable authentication data 219 to make multiple clones, those clones may not be able to authenticate with the authentication service 216. If the authentication service 216 authenticates one of the clones that first presents the cloned mutable authentication data 219, then the authentication service 216 may generate new mutable authentication data 219. Thus, the rest of the clones that still have the old authentication data and are unable to present the new mutable authentication data 219 would not be able to successfully authenticate with the authentication service 216.

In one implementation, the mutable authentication data 219 may be provided to the manufacturer of the client 250 and stored in the client 250 at manufacturing time. Alternatively, in another implementation, the client 250 may be manufactured without any authentication data. The client 250 may be issued the first mutable authentication data 219 by the authentication service 216 at the first time the client 250 attempts to be authenticated.

Consistent with some implementations of the present concepts, the client 250 may include multiple features (e.g., uses, functionalities, operations, etc.), and the client 250 may operate in one of multiple modes that enable and disable certain sets of capabilities. For example, the client 250 may operate in a pre-authentication mode in which all or a subset of the features may be enabled before the client 250 is authenticated by the authentication service 216. Furthermore, the client 250 may operate in an unauthenticated mode in which all or a subset of the features may be functional even after an attempt by the client 250 to authenticate fails. In one implementation, the unauthenticated mode may disable all functionalities of the client 250. Also, the client 250 may operate in an authenticated mode in which all or a subset of the features may be available after the client 250 has been authenticated by the authentication service 216. In one implementation, the pre-authentication mode and the authenticated mode may enable the same set of features of the client 250. The number and the types of modes, as well as the sets of functions permitted in each mode, can vary by design and enforcement of the authentication policies.

In one example scenario, the client 250 may be a game controller that can operate in a gameless mode even if the game controller has yet to be authenticated and/or has failed to be authenticated. In the gameless mode, the game controller may pair with a game console, interact with the game console's system user interface, change settings, and/or play movies, etc. However, the game console may prohibit inputs and outputs for game playing while the game controller is in the gameless mode. Alternatively, the gameless mode may permit local games and/or single-player games while prohibiting online games and/or multiplayer games.

In one implementation, the game controller may be permitted to operate in a game mode immediately upon booting up or connecting to the game console, while the authentication check runs in the background. If the authentication check fails, then the game controller may be switched to the gameless mode. This implementation avoids making the user wait for the authentication check to complete before starting to play games.

The client 250 may also operate in an offline mode, where the client 250 and/or the host 230 cannot or has failed to connect to the server 210, for example, due to lack of a reliable network connection. For example, the offline mode may allow the client 250 to function fully until the client 250 and/or the host 230 can connect to the server 210 or for a limited time period (e.g., one day, one week, etc.). Alternatively, the offline mode may limit the functionality of the client 250 similar to the unauthenticated mode (e.g., the gameless mode).

In one implementation, the client 250 may communicate directly with the authentication service 216 on the server 210. Alternatively, the client 250 may communicate with the server 210 through the host 230, as illustrated in FIG. 2.

The host 230 may include any computer, device, apparatus, machine, or accessory that can work with the client 250. For example, the host 230 may include a personal computer (“PC”) or a game console. Although FIG. 2 illustrates the host 230 as a hardware device, the host 230 may be a software module (e.g., an application, program, operating system, firmware, etc.) that may need to authenticate the client 250. Consistent with some implementations of the present concepts, the host 230 may attempt to authenticate the client 250 by using the authentication service 216 on the server 210. Depending on whether the authentication attempt succeeds or fails, the host 230 may enforce one or more authentication policies depending on the authentication results, for example, by enabling or disabling certain features of the client 250. That is, the host 230 may have the capability to operate the client 250 in one or more operational modes or force the client to operate in one or more operational modes.

In one implementation, the host 230 may facilitate communications between the client 250 and the server 210, for example, for the purpose of performing authentication checks. That is, the host 230 may act as a communication conduit between the client 250 and the server 210.

In some implementations, the host 230 may lessen the load on the server 210 by reducing the number of authentication requests received by the server 210 from the client 250. For example, the host 230 may include an authentication result cache 232 that temporarily stores the mutable authentication data 219 issued by the authentication service 216 to the client 250 in association with the client identifier 215 of the client 250. For instance, when the client 250 is powered on and the authentication service 216 issues new mutable authentication data 219 to the client 250, the host 230 may store the new mutable authentication data 219 in the authentication result cache 232 in association with the client identifier 215 of the client 250. Then, the next time the client 250 is powered on, the host 230, in lieu of the server 210, may authenticate the client 250 based on the cached mutable authenticate data 219 stored in the authentication result cache 232 without burdening the server 210.

The cached mutable authentication data 219 stored in the host 230 may be valid until a predetermined event (e.g., until the host 230 is shut down) and/or for a predetermined time (e.g., a day, a week, or a month, etc.). After the cached mutable authentication data 219 expires, the client 250 may be authenticated by the server 210 and be issued updated mutable authentication data 219, which may again be cached in the host 230. Accordingly, host 230 may serve as a proxy authentication service for the server 210. Since the host 230 may not issue new mutable authentication data 219 to the client 250, the client 250 may continue to be authenticated by the host 230 using the same mutable authentication data 219 up until the cached mutable authentication data 219 in the host 230 expires. Depending on the length of the expiration period, the server 210 may avoid being overloaded by frequent authentication requests from millions of clients 250.

Alternatively, the host 230 may simply store the client identifier 215 (or the certificate) of the client 250 and the date and time of the last successful authentication of the client 250 by the authentication service 216. Therefore, even without storing the mutable authentication data 219, the host 230 can still authorize the use of the client 250 for a predetermined period of time (e.g., a certain number of hours or days, etc.). These optimization techniques may also reduce the number of flash rewrites to the authentication data storage 254, thereby prolonging the useful life of flash memory in the client 250.

Each of the server 210, the host 230, and the client 250 may include personal computers, desktop computers, server computers, notebook computers, cellular phones, smartphones, personal digital assistants, tablets or pad type computers, mobile computers, cameras, appliances, virtual reality headsets, video game consoles, controllers, smart devices, loT devices, vehicles, watches, wearables, set-top boxes, game systems, automobile entertainment or navigation consoles, coffee makers, etc., and/or any of a myriad of ever-evolving or yet to be developed types of electronic devices. The number of the devices and the client-versus-server side of the devices described and depicted are intended to be illustrative and non-limiting.

The server 210, the host 230, and the client 250 may communicate with each other via wire (e.g., USB, ethernet, etc.), wirelessly (e.g., Wi-Fi, Bluetooth, infrared, near-field communication, etc.), and/or via one or more networks including the Internet. For example, the server 210, the host 230, and/or the client 250 may include communication modules, such as wireless radio chips, that can communicate using one or more communication protocols.

The term “device,” “computer,” or “computing device” as used herein can mean any type of device that has some amount of processing capability and/or storage capability. Processing capability can be provided by one or more hardware processors that can execute data in the form of computer-readable instructions to provide a functionality. Data, such as computer-readable instructions and/or user-related data, can be written on storage, such as storage that can be internal or external to the device. The storage can include any one or more of volatile or non-volatile memory, hard drives, flash storage devices, optical storage devices (e.g., CDs, DVDs etc.), and/or remote storage (e.g., USB drives or cloud-based storage), among others. As used herein, the term “computer-readable media” can include transitory propagating signals. In contrast, the term “computer-readable storage media” excludes transitory propagating signals. Computer-readable storage media may include computer-readable storage devices. Examples of computer-readable storage devices may include volatile storage media, such as RAM, and non-volatile storage media, such as hard drives, optical discs, and flash memory, among others.

FIG. 2 shows two example device configurations 270 that can be employed by any or all of the server 210, the host 230, and the client 250. The first configuration 270(1) may represent an operating system (“OS”) centric configuration. The second configuration 270(2) may represent a system on a chip (“SoC”) configuration. The first configuration 270(1) can be organized into one or more applications 272, an operating system 274, and hardware 276. The second configuration 270(2) may be organized into shared resources 278, dedicated resources 280, and an interface 282 there between.

Either configuration 270 may include a storage 284 and a processor 286. For example, the storage 284 in the server 210 may include the certificate database 214 and/or the authentication database 218, the storage 284 in the host 230 may include the authentication result cache 232, and the storage 284 in the client 250 may include the certificate storage 252 and/or the authentication data storage 254.

The configurations 270 may also include an authentication module 288. For instance, the authentication module 288 in the server 210 may implement the certificate issuing service 212 and/or the authentication service 216. The authentication module 288 in the host 230 may create a communication channel and relay messages between the client 250 and the server 210, initiate an authentication check, request that the client present a proof of authenticity, and/or enforce authentication results by placing the client 250 into one or more operational modes. In some implementations, the authentication module 288 in the host 230 may function as a proxy for the authentication service 216 in the server 210, and authenticate the client 250 based on the authentication result cache 232. The authentication module 288 in the client 250 may store the mutable authentication data 219 received from the server 210 and present the mutable authentication data 219 to be authenticated. The authentication module 288 in the client 250 may also receive and present any proof of authenticity (e.g., the result of a successful authentication check), as well as enforce the result of an authentication check by enabling or disabling certain parts of the client 250.

As mentioned above, the second configuration 270(2) includes an SoC type design, which may be integrated on a single SoC or multiple coupled SoCs. One or more processors 286 can be configured to coordinate with shared resources 278, such as storage 284, etc., and/or one or more dedicated resources 280, such as hardware blocks configured to perform certain specific functionality. Thus, the term “processor” as used herein can also refer to central processing units (CPUs), graphical processing units (GPUs), controllers, microcontrollers, processor cores, or other types of processing devices and integrated circuits.

Generally, any of the functions described herein can be implemented using software, firmware, hardware (e.g., fixed-logic circuitry), or a combination of these implementations. The term “component” or “module” as used herein generally represents software, firmware, hardware, whole devices or networks, or a combination thereof. In the case of a software implementation, for instance, these terms may represent program code that performs specified tasks when executed on a processor (e.g., CPU or CPUs). The program code can be stored in one or more computer-readable memory devices, such as computer-readable storage media. The features and techniques of the component or module may be platform-independent, meaning that they may be implemented on a variety of commercial computing platforms having a variety of processing configurations.

The system 200 illustrated in FIG. 2 is merely one example. The system 200 need not include all of the example elements described in connection with FIG. 2, and the system 200 may also include additional elements not explicitly described in connection with FIG. 2.

Communications

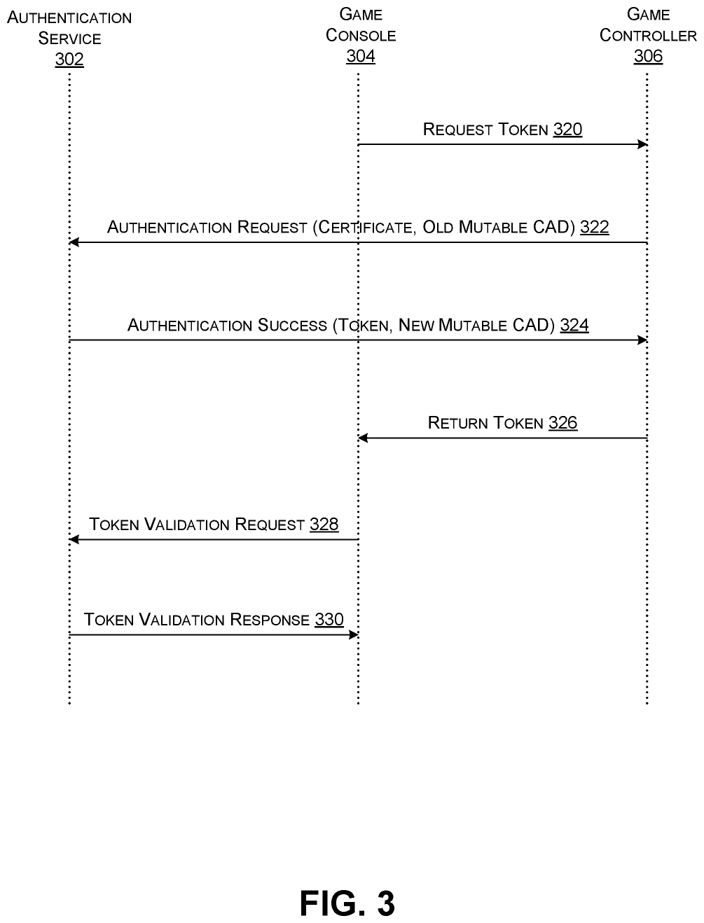

FIG. 3 illustrates example communications, consistent with some implementations of the present concepts. In connection with FIG. 3, example communications between an authentication service 302, a game console 304, and a game controller 306 involved in performing authentication checks will be described. However, the same or similar communications may be conducted by other types of hosts and clients. Any of the communications between the authentication service 302, the game console 304, and the game controller 306 discussed herein may be sent and received using or involving any communication techniques or protocols, such as representational state transfer (REST), transport layer security (TLS), JavaScript object notation (JSON), X.509 public key certificates, etc.

In one example scenario, the provider of the game console 304 may issue unique certificates to the manufacturer of the game controller 306, either directly or through a third party. The certificates may be provided in software or hardware. The unique certificates may include unique device identifiers (e.g., controller identifiers in this example). The provider of the game console 304 may store a copy of the certificates (or a copy of the device identifiers) in a database that is accessible by the authentication service 302. In some implementations of the present concepts, at the time of manufacturing the game controller 306, the manufacturer may durably store the unique certificate including the unique device identifier in a read-only storage in the game controller 306.

In one implementation, the authentication service 302 may issue unique mutable controller authentication data (CAD) for each game controller 306 (or for each unique certificate), and store the mutable CADs in association with device identifiers. The mutable CADs may be generated and issued by the provider of the game console 304 to the manufacturers of the game controllers 306, and each mutable CAD may be initially stored in each game controller 306 at the time of manufacture. Alternatively, in another implementation, the game controller 306 may be manufactured with no CAD (or a null CAD), and the game controller 306 may be issued a first mutable CAD by the authentication service 302 upon connecting to the authentication service 302 for the first time.

If a user powers on the game controller 306 and connects it to the game console 304 via wire or wirelessly, then the game console 304 and/or the game controller 306 may initiate communicating with each other. In some implementations, the game console 304 may allow the game controller 306 to operate in a restricted mode (e.g., a gameless mode) by allowing a certain set of features (e.g. those that do not involve playing games, such as navigating system menus on the game console 304 or playing movie DVDs). If the user wants to use the game controller 306 in an unrestricted mode (e.g., a game mode by initializing a game), then the game console 304 may validate the authenticity of the game controller 306. In one implementation, the game console 304 may validate the authenticity of the game controller 306 before allowing it to operate in the unrestricted mode.

However, the authentication check may add a delay (e.g., a couple of seconds or longer if errors occur) until the user can use the game controller 306 fully. To avoid this delay, in another implementation, the game console 304 may permit the game controller 306 to operate in the unrestricted mode before the game controller 306 is authenticated. Then, while the game controller 306 is being used in the unrestricted mode, the authentication check may be performed in the background. If the authentication check fails, then the game console 304 may enforce the failed authentication result by forcing the game controller 306 to operate in the restricted mode, and may display an error message to the user via a user interface about the failed authentication result. If the authentication check succeeds, then there may be no indication to the user, other than the continued ability to use the game controller 306 in the unrestricted mode. Alternatively, a message may be displayed to the user via a user interface about the successful authentication result.

In some implementations consistent with the present concepts, the game controller 306 may prove its authenticity by presenting a valid token (e.g., an accessory token) to the host 304, the server 302, or any other entity. The authentication service 302 may issue the valid token to the game controller 306 upon a successful authentication check.

In act 320, the game console 304 may request a token from the game controller 306. Act 320 may be initiated because a certain event triggered the game console 304 to test the authenticity of the game controller 306. For example, the game console 304 turning on, the game controller 306 turning on, the game controller 306 connecting to the game console 304, the user initiating a certain function of the game console 304 (e.g., by starting a game), or any other event may cause the game console 304 to ask the game controller 306 to present a token.

In some scenarios, the game console 304 may already have stored a cached token for the game controller 306 from a prior authentication check. However, if the cached token stored in the game console 304 is expired or invalid, then in act 320, the game console 304 may request a new token from the game controller 306 to validate the authenticity of the game controller 306.

If the game controller 306 already has a stored token cached in it, then in act 326, the game controller 306 may return the stored token to the game console 304. If the game controller 306 does not have any stored token (or the stored token has expired, is invalid, or is not accepted by the game console 304), then the game controller 306 may request a new token from the authentication service 302 (e.g., using a GetToken command). For example, in act 322, the game controller 306 may request a new token from the authentication service 302 by transmitting an authentication request to the authentication service 302.

In one implementation, the authentication request may be transmitted from the game controller 306 directly to the authentication service 302. Alternatively, in another implementation, the authentication request may be transmitted from the game controller 306 through the game console 304 and then to the authentication service 302. For example, the game console 304 may establish an encrypted communication channel between the game controller 306 and the authentication service 302. In one implementation, the game console 304 may receive the authentication request from the game controller 306 and relay the authentication request to the authentication service 302. In another implementation, the game console may establish a communication tunnel between the game controller 306 and the authentication service 302, where the game console acts as a communication conduit proxy and may even be unaware of the contents of the messages exchanged between the game controller 306 and the authentication service 302. Thus, the game controller 306 may use the game console 304 as a connection gateway to communicate with the authentication service 302.

In one implementation, the authentication request may include the device identifier of the game controller 306 (or include the certificate that includes the device identifier of the game controller 306) and/or the device identifier of the game console 304 (e.g., the serial number of the game console 304). Furthermore, the authentication request may include the mutable CAD stored in the game controller 306. Although act 322 has been described as the authentication request including the device identifier and the mutable CAD, this may be just a simplified description. Act 322 may be implemented in multiple stages through multiple exchanged messages, such as initial handshake messages to start communications and multiple stateless request and response messages. Furthermore, the device identifier and the mutable CAD may be sent separately from each other and/or sent separately from the authentication request message.

If the authentication request is being sent for the first time by the game controller 306, and the game controller 306 was manufactured without an initial mutable CAD, then the authentication request may not include a CAD, include a null or uninitialized CAD, or include a flag indicating that the game controller 306 is attempting to be authenticated for the first time. The authentication service 302 may receive the authentication request and perform an authentication check.

In the scenario where the game controller 306 is authenticating with the authentication service 302 for the first time, the authentication service 302 may check the device identifier of the game controller 306 that was included in the authentication request against a database of device identifiers. If the database indicates that the game controller 306 is requesting authentication for the first time, the authentication service may approve the authentication request without requiring a mutable CAD from the game controller 306.

In one implementation, the authentication service 302 may maintain a database of all issued certificates containing all device identifiers. Thus, the database may already include the device identifier of the game controller 306 that is requesting authentication for the first time along with a null CAD, no CAD (e.g., an empty field), or a flag indicating that a mutable CAD has never been generated for the device identifier. Alternatively, in another implementation, the device identifier of the game controller 306 that is requesting authentication for the first time may not exist in the database. The absence of the device identifier in the database may indicate that a mutable CAD has never been generated for this device identifier. In this case, the authentication service 302 may add the device identifier to the database in association with a newly generated mutable CAD (which will be explained below).

In one implementation, if the database indicates that this is not the first time the game controller 306 has requested authentication, then the authentication service 302 may send a message to the game controller 306 that a mutable CAD is required. And the game controller 306 may respond with the requested mutable CAD.

In the scenario where the game controller 306 is not authenticating for the first time, the authentication service 302 may compare the mutable CAD received from the game controller 306 to the mutable CAD stored in the database in association with the game controller 306. If the two mutable CADs match, then the authentication service 302 may approve the authentication request. In one implementation, the authentication request may be approved if the two mutable CADs are near matches. That is, even if the two mutable CAD are not perfectly identical but are similar enough (e.g., a 95% match or some other threshold), the authentication check may succeed to allow some leeway for bit flip errors or minor unintended data corruption. Because a wrong CAD from a cloned game controller tends to be very dissimilar to the correct mutable CAD stored by the authentication service 302, permitting such leeway may make the authentication service 302 more robust against unforeseeable errors.

By approving the authentication request, the authentication service 302 may generate a new token and/or a new mutable CAD for the game controller 306. The token may serve as proof that the game controller 306 is authentic for a specified validity period. In one implementation, the authentication service 302 may store the token that was issued to the game controller 306.

In one implementation, the token may be a bearer token, which may be randomly generated by the authentication service 302 and signed by a private key of the authentication service 302. Alternatively or additionally, the token may be a JSON web token (JWT). In other implementations, the authentication service 302 may use any other means of communicating to the game console 304 that the game controller 306 was successfully authenticated.

In one implementation, the token may include certain information (e.g., in fields) that enables the game console 304 to validate that the game controller 306 was successfully authenticated by the authentication service 302. For example, the token may include one or more of the following: the device identifier of the game controller 306, the time when the token was issued, the time when the token will expire, the device identifier of the game console 304, and/or the time when the mutable CAD was issued. Where the token includes the device identifier of the game console 304, the token may authorize the game controller 306 to be used with that particular game console 304.

Consistent with some implementations of the present concepts, upon successful authentication, the authentication service 302 may update the database and store the new mutable CAD in association with the device identifier of the game controller 306. In one implementation, the new mutable CAD may be a unique, randomly generated number or string (e.g., a nonce). The mutable CAD may be formatted and stored as a binary large object (blob). The mutable CAD may be opaque to the game controller 306 and the game console 304. That is, the game controller 306 and the game console 304 may have no need to interpret the mutable CAD. They may simply store and present the mutable CAD back to the authentication service 302.

The authentication service 302 may persistently store the new mutable CAD until the new mutable CAD is overwritten by yet a newer mutable CAD at the next successful authentication check by the game controller 306. Accordingly, in one implementation, the authentication service 302 may generate a new mutable CAD after every successful authentication check, such that the mutable CAD stored in the game controller 306 is mutable data that changes at every authentication check. Therefore, each time the authentication service 302 receives an authentication request from the game controller 306 that presents the correct latest mutable CAD, the authentication service 302 may be assured that the game controller 306 is the same physical device that was previously authenticated and was previously issued the latest mutable CAD.

In one implementation, the authentication service 302 may store one mutable CAD per device identifier. Thus, storing a new mutable CAD may overwrite the old mutable CAD already stored in the database. Alternatively, the authentication service 302 may store more than one mutable CAD per device identifier, for example, two, three, or any number of the most recently generated mutable CADs in association with the device identifier of the game controller 306. Storing multiple recently generated mutable CAD may allow the game controller 306 to successfully authenticate by presenting any one of the multiple stored mutable CADs. Storing at least two mutable CADs may be more resilient to any potential errors that occur while the game controller 306 receives and/or writes mutable CADs.

In act 324, upon approving the authentication request, the authentication service 302 may transmit an authentication success message to the game controller 306. In one implementation, the message may be transmitted from the authentication service 302 directly to the game controller 306. Alternatively, in another implementation, the message may be transmitted via the game console 304. In one implementation, the authentication success message may be sent to both of the game console 304 and the game controller 306. The authentication service 302 may inform the game console 304, using any communication techniques, that the game controller 306 has been successfully authenticated.

Consistent with some implementations of the present concepts, the authentication success message may include the token and/or the new mutable CAD. Similar to the authentication request discussed above, the token and the new mutable CAD may be sent separately from each other and/or sent separately from the authentication success message.

In one implementation, the new mutable CAD may be sent from the authentication service 302 to the game controller 306 unencrypted. Alternatively, the new mutable CAD may be encrypted when sent by the authentication service 302 to the game controller 306. The new mutable CAD may be encrypted using a per-controller key or a service-wide key, for example, using a hardware service module (HSM).

In one implementation, the game console 304 may locally cache the authentication result from the authentication service 302. The authentication result cache stored in the game console 304 may include, for example, the device identifier (or the entire certificate) of the game controller 306, the new mutable CAD issued by the authentication service 302, and/or an expiration time. Thus, the next time the game controller 306 tries to authenticate by presenting the new mutable CAD, the game console 304 may compare the new mutable CAD from the game controller 306 with the cached mutable CAD in the authentication result cache. If the two mutable CADs match, then the game console 304 may approve the authentication request without involving the authentication service 302. If the two mutable CADs do not match, then the game console 304 may clear the authentication result cache and contact the authentication service 302 to authenticate the game controller 306.

The expiration time for the authentication result cache in the game console 304 may be set by the game console 304 and/or by the authentication service 302. For example, the authentication service 302 may set a variable expiration time depending on the authentication history of the game controller 306. Where the game controller 306 has an authentication history involving suspicious and/or failed authentication attempts, the expiration time for the authentication result cache may be set to a short period of time (e.g., one day). Whereas, if the authentication history of the game controller 306 exhibits multiple consistent successful authentication attempts, then the expiration time may be set to a long period of time (e.g., one month).

The authentication result cache in the game console 304 may reduce service load on the authentication service 302. The default expiration time may be an hour, a day, a week, or any period of time, which may be adjusted. For example, the expiration time may be increased to relieve load on the authentication service 302 or decreased to prevent unauthorized clones. In one implementation, the authentication result cache may be cleared upon reboot or shutdown of the game console 304. Moreover, the authentication result cache may provide the added benefit of reducing the number of writes to the flash memory in the game controller 306 by reducing the number of new mutable CADs received and written by the game controller 306.

Consistent with some implementations of the present concepts, the game controller 306 may receive the authentication success message and store the new mutable CAD. Where this is the first authentication attempt by the game controller 306, the game controller 306 may simply store the new mutable CAD. Where this is not the first authentication attempt by the game controller 306, the game controller 306 may store the new mutable CAD by overwriting the old mutable CAD. Therefore, both the game controller 306 and the authentication service 302 may synchronously store the same mutable CAD. In the implementation where the game controller 306 stores more than one mutable CAD, the game controller 306 may store the new mutable CAD by overwriting the oldest mutable CAD in a first-in, first-out fashion. Alternatively, the game controller 306 may write the new mutable CAD into one of the multiple storage slots for multiple mutable CAD storage in a round-robin fashion. In one implementation, the authentication service 302 may direct the game controller 306 to overwrite a particular mutable CAD to ensure that the set of mutable CADs stored in the authentication service 302 is synchronized with the set of mutable CADs stored in the game controller 306. The game controller 306 may optionally encrypt the new mutable CAD locally before storing it, and then decrypt the new mutable CAD when fetching it for the next authentication request.

In one implementation, the game controller 306 may transmit a confirmation message or an acknowledgment message (e.g., ACK) to the authentication service 302 that the newly generated mutable CAD has been successfully committed to storage in the game controller 306. If the authentication service 302 does not receive a confirmation message within a certain time period, then the authentication service 302 may attempt to resend the new mutable CAD to the game controller 306 for a predetermined number of retries. The authentication service 302 may wait until receiving the confirmation message before updating the database by overwriting the old mutable CAD with the new mutable CAD. Alternatively, the authentication service 302 may store the new mutable CAD alongside the old mutable CAD, and then, upon receiving the acknowledgment message from the game controller 306, delete the old mutable CAD.

In one implementation, the game controller 306 may store the mutable CAD to memory, read the mutable CAD from memory, and send the mutable CAD along with the acknowledgment message to the authentication service 302. Thus, the authentication service 302 may confirm that the mutable CAD was correctly written to the game controller 306. This implementation may detect any corruption of the mutable CAD, for example, during transmission or through flash memory write glitches. If the mutable CAD received along with the acknowledgement message does not match the mutable CAD that was sent with the authentication success message, then the authentication service 302 may try resending the same mutable CAD, or generate and send a new mutable CAD to the game controller 306 up to a certain number of retries until the game controller 306 is able to successfully write the correct mutable CAD to its memory.

The game controller 306 may store the token received from the authentication service 302. In act 326, the game controller 306 may transmit the token to the game console 304 in response to the token request in act 320.

The game console 304 may receive the token from the game controller 306 and confirm that the token is valid in order to enforce the authentication policies and permit certain operations of the game controller 306. In one implementation, the game console 304 itself may validate the token by inspecting one or more fields in the token, such as confirming the device identifier of the game controller 306, the device identifier of the game console 304, the issuance time of the token, the expiration time of the token, and/or the issuance time of the mutable CAD. For example, the game console 304 may retrieve the public key of the authentication service 302 from the Internet and validate the token signature.

Additional or alternatively, in another implementation, the game console 304 may validate the token by communicating with the authentication service 302. For instance, in act 328, the game console 304 may send a token validation request to the authentication service 302 to ask whether this token was validly issued by the authentication service 302. The token validation request may include the token or include some or all of the information inside the token. In turn, the authentication service 302 may check that the token was validly issued by the authentication service 302 to the game controller 306 (e.g., to be used with the game console 304). In one implementation, the authentication service 302 may offer an application programming interface (API) for validating tokens. Through this API, the authentication service 302 may answer yes or no as to whether the token is valid. In act 330, the authentication service 302 may return a token validation response to the game console 304. The token validation response may confirm that the token was validly issued by the authentication service 302 or indicate an error that the token is invalid. Upon receiving the token validation response, the game console 304 may take appropriate actions, for example, in accordance with an appropriate authentication policy, such as permit the game controller 306 to operate in an unrestricted mode, continue operating the game controller 306 in the unrestricted mode, limit the game controller 306 to operate in a restricted mode, or disable the game controller 306.

The next time the game controller 306 is powered up or connects to the game console 304, or when the token expires, the above described methods, including acts 320-326 may be repeated. In act 322, the game controller 306 may present the latest mutable CAD to the authentication service 302. And, upon confirming that the mutable CAD stored in the game controller 306 matches the mutable CAD stored by the authentication service 302, the authentication service 302 may issue yet a newer mutable CAD to be stored in the game controller 306 and presented at the next authentication request. The use of frequently changing mutable CAD, consistent with the present concepts, may render counterfeit game controllers unable to authenticate.

A counterfeiter may manufacture one or more cloned game controllers that have the same certificate (and thus the same device identifier) as the game controller 306. However, a cloned game controller would fail to successfully authenticate with the authentication service 302, because the cloned game controller would be unable to present the latest mutable CAD that the authentication service 302 issued to the game controller 306. If a CAD that is presented by the cloned game controller does not match the mutable CAD stored in the database in association with the device identifier of the game controller 306, then the authentication check may fail and the authentication service 302 may reject the authentication request.

Upon rejecting the authentication request, the authentication service 302 may inform the game console 304 that the authentication request by the cloned game controller has failed. The authentication service 302 may also transmit an authentication failed message to the cloned game controller. The authentication failed message may include an error message indicating that the presented CAD does not match the stored mutable CAD. Because the authentication service 302 would not provide a valid token to the cloned game controller, the cloned game controller would not be able to present a valid token to the game console 304. Accordingly, the game console 304 may take appropriate enforcement actions against the cloned game controller. For example, the game console 304 may disconnect the cloned game controller or may force the cloned game controller to operate in a restricted mode.

If a malicious actor legitimately purchases an authentic, licensed game controller from the public market and clones multiple counterfeit game controllers that have the same device identifier as the authentic game controller, then the authentication service 302 may successfully authenticate the first game controller that requests authentication (whether the first is the authentic game controller or one of the cloned game controllers). Then, the first game controller may receive the first mutable CAD and be able to authenticate again with the authentication service 302 using the first mutable CAD. Thus, the first game controller may continue to be used in the future, repeatedly receiving new mutable CADs. However, any other game controller that has the same device identifier would fail to authenticate and thus may not be used.

Consistent with the present concepts, the authentication service 302 need not be able to discern between an authentic game controller versus a cloned game controller. However, because the authentication service 302 permits only one of the multiple game controllers that share the same device identifier to be operational, the malicious actor may nonetheless be sufficiently deterred from manufacturing counterfeit game controllers.

In one implementation, the authentication service 302 may track the number of failed authentication requests for the device identifier of the game controller 306. Multiple cloned game controllers having the same device identifier trying to authenticate may increase the number of failed authentication requests. If the number of failed authentication request exceeds a certain threshold over a given time period, the authentication service 302 may block future authentication requests from the game controller 306 by adding the device identifier to a revocation list. Thus, the next time a game controller having a revoked device identifier tries to authenticate, the authentication service 302 may check the device identifier against the revocation list and deny the authentication request. This implementation would disable the set of cloned game controllers sharing the same device identifier. The revocation of device identifiers may be permanent or temporary for a certain lockout period.

In one implementation, the authentication service 302 may track the geographical location of the game controller 306 that attempts to authenticate. The geographical location may be obtained via a parameter in the authentication request, based on the internet protocol (IP) address, or any other means. Therefore, the authentication service 302 may reject an authentication request based on the geographical location of the game controller 306. For instance, if multiple authentication requests are received for the same device identifier 1,000 miles apart within 10 minutes, then the authentication service 302 may flag the authentication request as being suspicious and deny the authentication requests. The authentication service 302 may also add the device identifier of the game controller 306 to the revocation list. In one implementation, the authentication service 302 may use the device identifier of the game console 304 in the authentication request for detecting suspicious behavior. For example, if the game controller 306 connects to many different game consoles within a short period of time, then the authentication service 302 may add the device identifier of the game controller 306 to the revocation list.

If the authentication request fails, then the game console 304 may determine the appropriate consequences based on enforcement policies, for example, limiting the game controller 306 to operate in a restricted mode, completely disabling the game controller 306, and/or transmitting telemetry event data. The authentication enforcement policies may be set by the authentication service and/or the game console 304.

In one implementation, the game console 304 may cache the mutable CAD that is sent from the authentication service 302 to the game controller 306. Thus, the next time the game console 304 tries to authenticate by sending the mutable CAD to the game console 304, the game console 304 may compare the mutable CAD received from the game controller 306 with the cached mutable CAD stored in the game console 304, and approve the authentication request without involving the authentication service 302. Accordingly, the cached mutable CAD in the game console 304 may relieve the load on the authentication service 302. The game console 304 and/or the authentication service 302 may set an expiration time for the cached mutable CAD.

In one implementation, the storage in the game controller 306 may include two slots for storing the two most recently received mutable CADs. When authenticating, the game controller 306 may present both mutable CADs to the authentication service 302. The authentication service 302 may approve the authentication request if either of the two presented mutable CADs matches any of the mutable CADs stored in the database in association with the device identifier of the game controller 306 by the authentication service 302.

In one implementation, the authentication service 302 and the game controller 306 may store a historical record of mutable CADs. That is, rather than overwriting an old mutable CAD with a new mutable CAD, the new mutable CAD may be appended to the old mutable CAD, such that each mutable CAD is an authentication history entry in a set of concatenated mutable CADs. Therefore, both of the authentication service 302 and the game controller 306 may store a synchronized authentication history of mutable CADs. Accordingly, the game controller 306 may present not only the newest mutable CAD but an authentication history of mutable CADs in order to be authenticated by the authentication service 302. The authentication history of mutable CADs may hold a predefined number of mutable CADs (e.g., five mutable CADs, ten mutable CADs, one hundred mutable CADs, or a fixed number of bits, etc.) in a first-in, first-out fashion. This implementation may deter a malicious actor who intercepts the latest mutable CAD during transmission, since presenting only the latest mutable CAD to the authentication service 302 would fail to authenticate a cloned game controller having only the latest mutable CAD but not the entire authentication history.

Processes

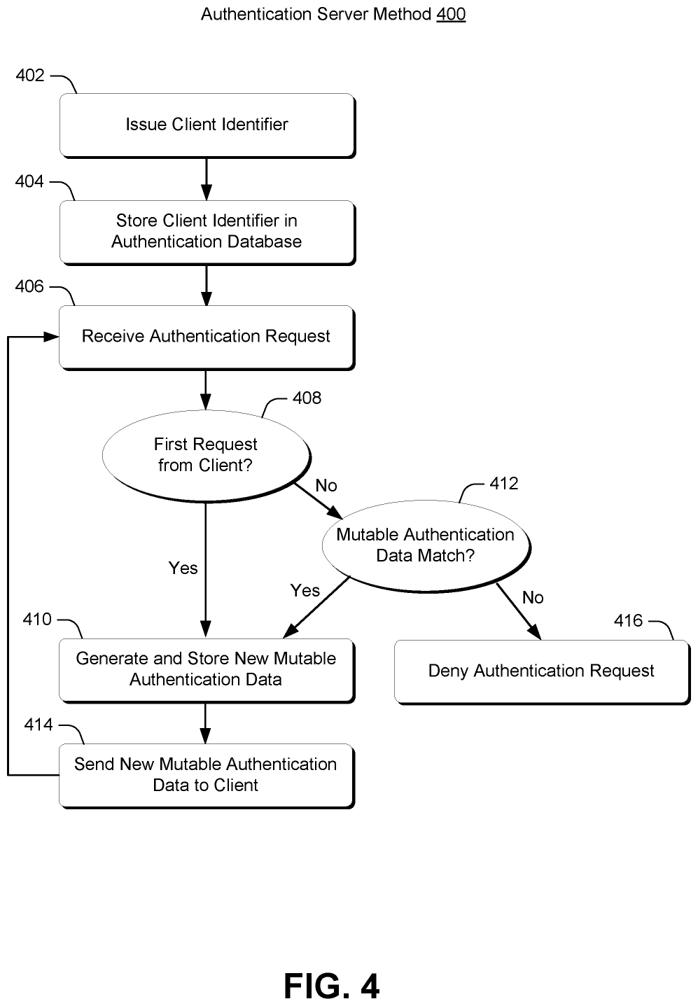

FIG. 4 illustrates a flow diagram of an example authentication server method 400, consistent with some implementations of the present concepts. The authentication server method 400 is presented for illustration purposes and is not meant to be exhaustive or limiting. The acts in the authentication server method 400 may be performed in the order presented, in a different order, or in parallel or simultaneously, may be omitted, and may include intermediary acts therebetween.

In act 402, a client identifier may be issued for a client. The client identifier may be unique to the client, and therefore, different client identifiers may be issued to different clients. For example, a unique device identifier may be issued to a physical device, such as a game controller. Where the client is a game controller, a unique game controller identifier may be issued. For instance, the client identifier may be included in a certificate signed by an appropriate and trusted certificate authority. The client identifier may be stored in the client, for example, at the time of manufacturing the client.

Optionally, in act 404, the client identifier may be stored in an authentication database. In one implementation, the client identifier may be stored in the authentication database in association with an indication that the client has not yet requested authentication. The indication may include a flag, null authentication data, or the absence of any authentication data. For example, the unique game controller identifier (or the entire certificate containing the identifier) may be stored in the authentication database. Alternatively, act 404 may be skipped, and the client identifier may be added to the authentication database in a later act described below.

In act 406, an authentication request may be received from the client. The authentication request may include the client identifier assigned to the client. For example, in one implementation, the authentication request may include the certificate assigned to the game controller.

In one scenario, the authentication request may include an indication that the client is requesting authentication for the first time. For example, the authentication request may include a flag, null or uninitialized authentication data, or no authentication data at all.

In another scenario, where this is not the first time the client has requested authentication or where the client was manufactured with mutable authentication data, the authentication request may include mutable authentication data. For example, the authentication request from the game controller may include the mutable CAD that is stored in the game controller.

In act 408, a determination may be made as to whether this is the first time the client is requesting authentication. In one implementation, this determination may be made by checking the authentication database for the client identifier that was included in the authentication request. If the client identifier is absent from the authentication database (e.g., where act 404 was skipped) or if the client identifier is present in the authentication database (e.g., because act 404 was performed) along with an indication that the client has yet to request authentication, then a determination may be made that the client is requesting authentication for the first time. Conversely, if the client identifier is present in the authentication database along with mutable authentication data, then a determination may be made that this is not the first time the client is requesting authentication.

If the client is requesting authentication for the first time, then in act 410, new mutable authentication data may be generated and stored in association with the client identifier in the authentication database. For example, the authentication database may store the certificate of the client in association with a new mutable CAD. Where act 404 was skipped, the client identifier may be added to the authentication database for the first time along with the first mutable authentication data. Where act 404 was performed, the indication that the client has yet to request authentication may be removed, for example, by modifying the flag and/or by storing the new mutable authentication data in association with the client identifier.

If the client is not requesting authentication for the first time (i.e., the client has requested authentication before), then in act 412, a determination may be made as to whether the mutable authentication data that is received from the client in act 406 matches the mutable authentication data that is stored in the authentication database in association with the client identifier. For example, the mutable CAD that is included in the authentication request from the game controller may be compared with the mutable CAD stored in the authentication database. Therefore, act 412 may determine whether the client that is requesting authentication now is the same client that was previously authenticated and was issued the mutable authentication data that is stored in the authentication database.

If the mutable authentication data presented by the client matches the mutable authentication data stored in the authentication database, then in act 410, new mutable authentication data may be generated and stored in association with the client identifier in the authentication database. Act 410 may involve overwriting the old mutable authentication data that was stored in association with the client identifier in the authentication database with the new mutable authentication data. For example, the old mutable CAD that is associated with the certificate of the game controller in the authentication database may be replaced with the new mutable CAD.

In act 414, the new mutable authentication data may be sent to the client. For example, an authentication success message may be sent to the client in response to the authentication request in act 406, and the authentication success message may include the new mutable authentication data.

If the mutable authentication data presented by the client does not match the mutable authentication data stored in the authentication database, then in act 416, the authentication request may be denied. This technical result may occur where a cloned client, having the same client identifier as the authentic client, sent the authentication request with outdated mutable authentication data that does not match the latest mutable authentication data that is stored in the authentication database. That is, the cloned client did not receive the latest mutable authentication data, because the latest mutable authentication data was sent to the authentic client.

Accordingly, when the authentic client requests authentication again in act 406, the authentic client may present the latest mutable authentication data that matches the mutable authentication data that is stored in the authentication database, and the authentication request would be approved. And then, yet another, even newer mutable authentication data may be generated and stored in the authentication database in act 410, and sent to the authentic client in act 414.

In some implementations, the authentication result may be sent to a host (in addition to sending the authentication result to the client) so that the host can take appropriate enforcement actions. For example, the host may receive a notification that the client was successfully authenticated, and in turn, permit the client to perform a certain set of operations. Conversely, the host may receive a notification that the client failed the authenticate check, and in turn, prohibit the client from performing a certain set of operations.

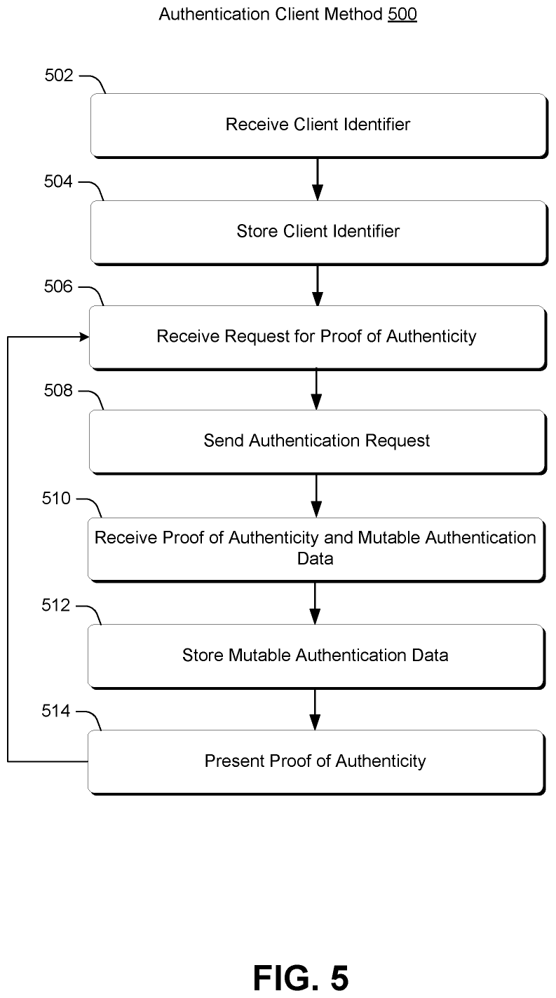

FIG. 5 illustrates a flow diagram of an example authentication client method 500, consistent with some implementations of the present concepts. The authentication client method 500 is presented for illustration purposes and is not meant to be exhaustive or limiting. The acts in the authentication client method 500 may be performed in the order presented, in a different order, or in parallel or simultaneously, may be omitted, and may include intermediary acts therebetween.

In act 502, a client identifier may be received from a server. The client identifier may be a unique identifier, such that every authentic client has a different unique identifier compared to other authentic clients. In one implementation, the client identifier may be included in a signed certificate issued to the client.

In act 504, the client identifier may be stored in the client. For example, the client (e.g., a game controller) may be manufactured with the client identifier stored in memory inside the client. Additionally, in one implementation, the client may be manufactured with no mutable authentication data, null mutable authentication data, a flag, or some other indication that the client has yet to receive mutable authentication data because the client has yet to be authenticated.

In act 506, a request for proof of authenticity may be received. In one implementation, the request for proof of authenticity may be received from a host. For example, the game controller may receive a request for a token (which would serve as a proof of authenticity) from a game console. Other paradigms for proving authenticity may be used besides a token. In other implementations, the request for proof of authenticity may be received from the server. Act 506 may be performed in response to the client turning on, activating, connecting, and/or using a certain feature.

In act 508, an authentication request may be sent to the server to obtain the proof of authenticity. The authentication request may include the client identifier. For example, the game controller may send the certificate to an authentication server.

Where the authentication request is being sent for the first time, the authentication request may include no mutable authentication data, null mutable authentication data, a flag, or some indication that the authentication request is being sent for the first time. Because the first authentication request may be approved without having to present the correct mutable authentication data, the first authentication request need not include any mutable authentication data. Alternatively, there may be no need to indicate to the server that the authentication request is being sent for the first time, because the server has a way of determining that the authentication request is being sent for the first time, as explained above.

Where the authentication request is not being sent for the first time, the authentication request may include mutable authentication data that was received in act 510 (explained below) and stored in the client in act 512 (explained below). For example, the game controller may read the mutable CAD stored in its storage and include the mutable CAD in the authentication request that is sent to the authentication server. As mentioned above, although the authentication request is described as including the mutable authentication data, the mutable authentication data may be sent separately from the authentication request. For example, after sending the authentication request, a request for mutable authentication data may be received, and then the mutable authentication data may be sent.

In act 510, a proof of authenticity and mutable authentication data may be received from the server. The server may send the proof of authenticity and new mutable authentication data in response to approving the authentication request, because the latest mutable authentication data that was sent in act 508 matched the latest mutable authentication data that was stored in the server. In one example, the game controller may receive a token and the latest mutable CAD from the authentication server.

In act 512, the mutable authentication data may be stored. For example, the game controller may store the received mutable CAD in its storage to be presented again to the authentication server at the next authentication check.

Where the authentication request in act 508 was sent for the first time, the mutable authentication data received in act 510 may be added to the storage in the client (perhaps for the first time). For example, the game controller may receive a mutable CAD for the first time and store the mutable CAD in its memory.

Where the authentication request in act 508 was not sent for the first time, the updated mutable authentication data received in act 510 may overwrite the previously stored mutable authentication data in the client. For example, the game controller may overwrite an old mutable CAD in memory with the new mutable CAD most recently received from the authentication server.

In act 514, the proof of authenticity may be presented. Where the request for proof of authenticity was received from a host in act 506, the proof of authenticity may be sent to the host. For example, the game controller may present the token to the game console. In turn, the game console may permit certain operations using the game controller, such as playing games, etc. Alternatively, where the request for proof of authenticity was received in act 506 from another entity, the proof of authenticity may be sent to the requesting entity to prove that the client is authentic, not a counterfeit.

When a request for proof of authenticity is received again in act 506, the client may send another authentication request again in act 508 to the server by reading the most recently stored mutable authentication data that was most recently received in act 510 at the last authentication check and including the most recently stored mutable authentication data in the authentication request. For example, the game controller may read the mutable CAD stored its memory and send the mutable CAD to the authentication server. If the authentication server authenticates the game controller, then the authentication server may send an even newer mutable CAD to the game controller for storage. Thus, in one implementation, the mutable CAD stored in the authentication server and in the game controller may be updated upon each successful authentication check.

If a cloned client, having the same client identifier as the authentic client, sends an authentication request with outdated mutable authentication data that does not match the latest mutable authentication data that is stored by the server, then the authentication request may be rejected. Thus, even if a counterfeiter makes many cloned game controllers that all have the same certificate, only one of the game controllers may be authenticated and the rest will not. It may not be necessary for the authentication server to be able to definitively identify which game controller is authentic and which game controller is cloned. So long as the authentic game controller and the cloned game controllers cannot all function fully (i.e., only one can be authenticated and the rest cannot), the counterfeiter may be sufficiently deterred from making and selling cloned game controllers.

Resiliency

In some implementations of the present concepts, one or more resiliency techniques may be incorporated to account for and/or handle certain conditions and/or errors. For example, where the host cannot communicate with the authentication service to perform an authentication check and/or to validate a token, the host may permit the client to operate in an unrestricted manner or status regardless of whether the client can provide a valid token. For instance, the game console may be offline because the network cable has been unplugged from the game console or because the Wi-Fi router to which the game console is connected may be experiencing network connectivity issues with an unreliable Internet service. Alternatively, the authentication service may be offline temporarily while experiencing a service outage or while being down for a scheduled maintenance. In such situations, the game console may permit the game controller to operate in the game mode regardless of whether the game controller has the latest mutable CAD and even if the game controller cannot provide a valid token. If the game console is offline, then the game console may skip the acts of contacting the authentication service. If the game console is online but the authentication service is offline, then the game console may periodically retry to connect to the authentication service. Once the game console is able to connect to the authentication service (e.g., the game console and the authentication service are online), then the game console may require the game controller to authenticate and present a valid token in order to continue operating in the game mode.

There is a possibility that a cloned game controller may be used while the game console is offline or while the authentication service is interrupted. To address this possibility, in one implementation, a game controller may be permitted to operate in an unrestricted mode without authenticating only temporarily (e.g., an hour, a day, a week, or a month) so that a cloned game controller cannot be used indefinitely by simply disconnecting the game console from the Internet. As discussed above, it may not be necessary to perfectly detect every cloned game controller and deny all uses of cloned game controller at all times. Even if a cloned game controller could be used sometimes briefly, interrupting the continual use of a cloned game controller frequently enough that a user of the cloned game controller would be dissatisfied may be sufficient to deter counterfeiters from making and selling cloned game controllers.

In one implementation, the mutable authentication data may be periodically reset by the authentication service. That is, at every regular interval (e.g., an authentication data reset period), the authentication service may reset the mutable authentication data (i.e., regenerate and reissue new mutable authentication data) regardless of whether the client presented the correct latest mutable authentication data. For example, when the authentication service receives a request for authentication from the client, the authentication service may check if the authentication data reset period has expired since the last time the reset period was restarted and/or if the duration of time from the last successful authentication until the receipt of the current request for authentication is longer than the authentication data reset period. If so, then the authentication service may initiate a reset of the mutable authentication data. This implementation may render the authentication service more resilient to potential errors.

For example, the client may lose connection to the authentication service during a handshake or experience other communication problems. The client may also experience read or write problems (e.g., random erroneous bit flips) while storing or fetching the mutable authentication data from storage. For any number of reasons, the mutable authentication data stored in the client may become out-of-sync with the mutable authentication data stored in the authentication service. To handle such problems, the authentication service may periodically (e.g., weekly, bi-weekly, or monthly) issue new mutable authentication data to the client regardless of whether the client presents the correct latest mutable authentication data.

By resetting the mutable authentication data, the client and the authentication service can again have synchronized mutable authentication data. Such an authentication data reset may reenable an authentic client that was previously disabled due to a communication error and/or a storage read/write error. So, for example, once a week (or however long the authentication data reset period may be), the authentication service may unconditionally permit a game controller to receive a new mutable CAD. That way, the authentication service would not permanently disable an authentic game controller despite any errors it may experience.

Although a cloned client may also be enabled as a result of an authentication data reset, the cloned client may be disabled again at the next authentication data reset (i.e., at the expiration of the next authentication data reset period). That is, at each reset of the mutable authentication data, only one of the many cloned clients may be enabled but the rest will be disabled. In certain applications where absolute prohibition of clones are not necessary (e.g., in the context of game controllers) and some minimal use of clones may be tolerated, the present concepts need not disable all clones at all times to combat counterfeiters. If cloned game controllers are disabled enough times to frustrate or even anger gamers, then counterfeiters would lose customers quickly and thus be deterred from making and selling cloned controllers.

In one implementation, the user may manually initiate an authentication data reset for a client that fails to authenticate due to an error. For example, the user may manually place the client in a recovery mode, which may cause the authentication service to issue new mutable authentication data to the client by performing the authentication data reset. In one implementation, the user may need to call customer support and provide identity credentials or the user may need to supply a password (e.g., by logging in) to the client and/or to the authentication service to reset the mutable authentication data. Thus, if a client experiences an error and the client does not have the latest mutable authentication data to successfully authenticate, then the user need not wait for the expiration of the current authentication reset period. Instead, the user can manually initiate an authentication data reset in the recovery mode in order to have the client obtain new mutable authentication data and regain the use of the client.

In one implementation, the authentication service may limit a user to performing a manual authentication data reset in recovery mode to only a limited number of times within a defined period of time (e.g., once a week, once per authentication reset period, five times a month, etc.). That way, a user cannot continue to use a cloned client by repeatedly resetting the mutable authentication data in recovery mode. Alternatively, the authentication service may automatically initiate recovery mode and reset the mutable authentication data as soon as a client fails to authenticate. The authentication service may allow automatic resets of mutable authentication data only a limited number of times.

Advantages

The present concepts described herein provide technological solutions of authenticating authorized clients and blocking unauthorized clients using software-based authentication techniques that involve mutable authentication data. The present concepts address technological problems associated with hardware-based authentication techniques and other software-based authentication techniques that use static authentication data (e.g., security chips with secret information) that counterfeiters can extract and copy to make unauthorized cloned clients. Even though the present concepts may not be able to prevent counterfeiters from actually making and selling cloned clients, the present concepts can prevent cloned clients from functioning fully. The inability of cloned clients to be used satisfactorily by customers would financially deter counterfeiters from making and selling cloned clients.

Because the present concepts do not require discrete security integrated circuits (ICs), the cost of manufacturing authorized client devices and/or the cost of implementing authentication checks may be reduced. Also, the present concepts of authentication would not be subject to manufacturing delays, production problems, factory shutdowns due to pandemics, security chip shortages, and/or component supply chain issues. Thus, the present concepts provide a technical anticloning solution that is hardware and encryption neutral. Thus, as hardware and security improvements are made and countered by malicious actors, the present anticloning solutions continue to be effective. Further, the present concepts provide technical solutions that do not require hardware changes and can be implemented on existing and developing hardware with equal effectiveness.

Furthermore, the present concepts that use software-based authentication techniques are more versatile, i.e., can be more easily, quickly, and cheaply modified, by changing the software, e.g., via updates and patches. Conversely, conventional hardware-based authentication techniques are difficult, if not impractical, to change, because any desired change would require redesigning, manufacturing, and replacing the security chips installed in client devices.

The present concepts exploit the ease of updating software data in client devices by issuing and frequently changing mutable authentication data stored in client devices. Although a counterfeiter can copy and install one certificate into multiple clones during manufacturing one time, it is extremely difficult for a counterfeiter to copy and install mutable authentication data to multiple clones. Moreover, even if a counterfeiter copied the mutable authentication data and installed it in multiple clones, because the present concepts dynamically change the mutable authentication data, the clones would not be functional. And, of course, it is nearly impossible for the counterfeiter to continue to copy every newly issued mutable authentication data into all of the multiple clones on an ongoing basis. Accordingly, the present concepts provide a cheap, versatile, and reliable authentication techniques for deterring clones.

Moreover, the authentication techniques consistent with the present concepts may be made more robust by implementing one or more resiliency techniques that can address potential errors or unforeseen problems. As discussed above, the authentication service may allow a bit of leeway for clients to authenticate even without providing the latest mutable authentication data. This leeway (i.e., some level of less-than-perfect authentication checks) can be tolerated because counterfeiters can be sufficiently deterred even if the clones can be used sometimes but not all the time. For example, most gamers would be extremely dissatisfied if their game controllers did not work every time they want to play games. Accordingly, the counterfeiters may lose customers, and the counterfeiters would not be able to compete with legitimate manufacturers of client devices and/or licensors of client devices.

Applications

The present concepts and the many example implementations above have been explained in the context of authenticating game controllers. However, the present concepts have a much wider range of applications. The present concepts may be implemented in any server that can perform authentication checks, so long as the server can generate and store mutable authentication data. The present concepts may be implemented in any client that may need to be authenticated, so long as the client can store and rewrite mutable authentication data. The client may be any hardware device (e.g., game controller, game console, computer, smartphone, headphones, keyboard, card, badge, car, key, switch, watch, camera, storage device, remote control, appliance, integrated circuit, etc.) or any software module (e.g., application, program, game, file, service, operating system, driver, adware, etc.), so long as the module can receive, store, and present mutable authentication data that can be overwritten with newer mutable authentication data.

The present concepts may be applied in the context where the server enforces the authentication results. The present concepts may also be applied in the context where a separate host enforces the authentication results. For example, the host may be a game console, computer, car, door, switch, or any hardware or software that can enable, disable, accept, reject, detect, or use the clients.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

Various examples are described above. Additional examples are described below. One example includes a system comprising a storage including first mutable authentication data in association with an identifier of a client and a processor for executing instructions that cause the processor to: receive an authentication request for the client along with second mutable authentication data. In response to determining that the first mutable authentication data matches the second mutable authentication data: generate third mutable authentication data that is different from the first mutable authentication data, store the third mutable authentication data in association with the identifier of the client in the storage, and transmit the third mutable authentication data for storage in the client.

Another example can include any of the above and/or below examples where the instructions further cause the processor to, in response to determining that the first mutable authentication data does not match the second mutable authentication data, transmit a denial of the authentication request.

Another example can include any of the above and/or below examples where the third mutable authentication data includes a random string.

Another example can include any of the above and/or below examples where storing the third mutable authentication data in the storage overwrites the first mutable authentication data.

Another example can include any of the above and/or below examples where the storage includes multiple recent mutable authentication data in association with the identifier of the client.

Another example can include any of the above and/or below examples where the instructions further cause the processor to, in response to determining that the second mutable authentication data matches any one of the multiple recent mutable authentication data, generate and transmit the third mutable authentication data for storage in the client.

Another example includes a computer-implemented method comprising storing, in a database, first mutable authentication data in association with an identifier of a client, receiving a request for authentication of the client, the request including second mutable authentication data stored in the client, comparing the first mutable authentication data in the database with the second mutable authentication data, and in response to determining that the first mutable authentication data matches the second mutable authentication data: generating third mutable authentication data that is different from the first mutable authentication data, storing, in the database, the third mutable authentication data in association with the identifier of the client, and transmitting the third mutable authentication data for storage in the client.

Another example can include any of the above and/or below examples where the computer-implemented method further comprises, in response to determining that the first mutable authentication data does not match the second mutable authentication data, transmitting a denial of the request for authentication

Another example can include any of the above and/or below examples where the third mutable authentication data is randomly generated.

Another example can include any of the above and/or below examples where the computer-implemented method further comprises generating the identifier that is uniquely assigned to the client.

Another example can include any of the above and/or below examples where the computer-implemented method further comprises in response to determining that the first mutable authentication data matches the second mutable authentication data, transmitting a token of authenticity to the client.

Another example can include any of the above and/or below examples where the computer-implemented method further comprises determining whether the request for authentication is received for the first time for the client.

Another example can include any of the above and/or below examples where the computer-implemented method further comprises in response to determining that the request for authentication is received for the first time for the client, generating and transmitting the third mutable authentication data without comparing the first mutable authentication data with the second mutable authentication data.

Another example can include any of the above and/or below examples where the computer-implemented method further comprises determining whether the request for authentication is received after an authentication data reset period has expired.

Another example can include any of the above and/or below examples where the computer-implemented method further comprises, in response to determining that the request for authentication is received after the authentication data reset period has expired, generating and transmitting the third mutable authentication data without comparing the first mutable authentication data with the second mutable authentication data.

Another example includes a system comprising one or more storages including an identifier and first mutable authentication data and processor for executing instructions that cause the processor to: transmit a first request for authentication along with the first mutable authentication data, upon a success of the first request for authentication: receive second mutable authentication data that is different from the first mutable authentication data, and store the second mutable authentication data in the one or more storages, and transmit a second request for authentication along with the second mutable authentication data.

Another example can include any of the above and/or below examples where storing the second mutable authentication data overwrites the first mutable authentication data.

Another example can include any of the above and/or below examples where the instructions further cause the processor to, upon the success of the first request for authentication, receive a token from an authentication service.

Another example can include any of the above and/or below examples where the instructions further cause the processor to receive a request for the token from a host and upon the success of the first request for authentication, present the token to the host.

Another example can include any of the above and/or below examples where the system further comprises a game controller including the one or more storages and the processor.

1. A system, comprising:
a storage including first mutable authentication data in association with an identifier of a client; and
a processor for executing instructions that cause the processor to:
receive an authentication request for the client along with second mutable authentication data; and
in response to determining that the first mutable authentication data matches the second mutable authentication data:
generate third mutable authentication data that is different from the first mutable authentication data;
store the third mutable authentication data in association with the identifier of the client in the storage; and
transmit the third mutable authentication data for storage in the client.

2. The system of claim 1, wherein the instructions further cause the processor to:
in response to determining that the first mutable authentication data does not match the second mutable authentication data, transmit a denial of the authentication request.

3. The system of claim 1, wherein the third mutable authentication data includes a random string.

4. The system of claim 1, wherein storing the third mutable authentication data in the storage overwrites the first mutable authentication data.

5. The system of claim 1, wherein the storage includes multiple recent mutable authentication data in association with the identifier of the client.

6. The system of claim 5, wherein the instructions further cause the processor to:
in response to determining that the second mutable authentication data matches any one of the multiple recent mutable authentication data, generate and transmit the third mutable authentication data for storage in the client.

7. A computer-implemented method, comprising:
storing, in a database, first mutable authentication data in association with an identifier of a client;
receiving a request for authentication of the client, the request including second mutable authentication data stored in the client;
comparing the first mutable authentication data in the database with the second mutable authentication data; and
in response to determining that the first mutable authentication data matches the second mutable authentication data:
generating third mutable authentication data that is different from the first mutable authentication data;
storing, in the database, the third mutable authentication data in association with the identifier of the client; and
transmitting the third mutable authentication data for storage in the client.

8. The computer-implemented method of claim 7, further comprising:
in response to determining that the first mutable authentication data does not match the second mutable authentication data, transmitting a denial of the request for authentication.

9. The computer-implemented method of claim 7, wherein the third mutable authentication data is randomly generated.

10. The computer-implemented method of claim 7, further comprising:
generating the identifier that is uniquely assigned to the client.

11. The computer-implemented method of claim 7, further comprising:
in response to determining that the first mutable authentication data matches the second mutable authentication data, transmitting a token of authenticity to the client.

12. The computer-implemented method of claim 7, further comprising:
determining whether the request for authentication is received for the first time for the client.

13. The computer-implemented method of claim 12, further comprising:
in response to determining that the request for authentication is received for the first time for the client, generating and transmitting the third mutable authentication data without comparing the first mutable authentication data with the second mutable authentication data.

14. The computer-implemented method of claim 7, further comprising:
determining whether the request for authentication is received after an authentication data reset period has expired.

15. The computer-implemented method of claim 14, further comprising:
in response to determining that the request for authentication is received after the authentication data reset period has expired, generating and transmitting the third mutable authentication data without comparing the first mutable authentication data with the second mutable authentication data.

16. A system, comprising:
one or more storages including an identifier and first mutable authentication data; and
a processor for executing instructions that cause the processor to:
transmit a first request for authentication along with the first mutable authentication data;
upon a success of the first request for authentication:
receive second mutable authentication data that is different from the first mutable authentication data; and
store the second mutable authentication data in the one or more storages; and
transmit a second request for authentication along with the second mutable authentication data.

17. The system of claim 16, wherein storing the second mutable authentication data overwrites the first mutable authentication data.

18. The system of claim 16, wherein the instructions further cause the processor to:
upon the success of the first request for authentication, receive a token from an authentication service.

19. The system of claim 18, wherein the instructions further cause the processor to:
receive a request for the token from a host; and
upon the success of the first request for authentication, present the token to the host.

20. The system of claim 16, further comprising:
a game controller including the one or more storages and the processor.
